(19) United States
(12) Patent Application Publication
(10) Pub. No.: US 2024/0337392 A1
(43) Pub. Date: Oct. 10, 2024

(54) AIR CONDITIONING DEVICE

(71) Applicant: Samsung Electronics Co., Ltd., Suwon-si (KR)

(72) Inventors: Junggeon KIM, Suwon-si (KR); Hyunho KIM, Suwon-si (KR); Yongjae SONG, Suwon-si (KR); Kiseok KIM, Suwon-si (KR); Heedong NO, Suwon-si (KR); Duhan JUNG, Suwon-si (KR)

(21) Appl. No.: 18/744,262

(22) Filed: Jun. 14, 2024

Related U.S. Application Data
(63) Continuation of application No. PCT/KR2022/019121, filed on Nov. 29, 2022.

(30) Foreign Application Priority Data
Jan. 28, 2022 (KR) 10-2022-0012826

(51) Int. Cl. F24F 1/12; F24F 13/24

(52) U.S. Cl. CPC F24F 1/12; F24F 13/24; F24F 2013/242

(57) ABSTRACT

The present disclosure relates to a noise shielding device for implementing low noise in a heat pump outdoor unit of an air conditioning device (e.g. an air conditioner). The noise shielding device may comprise: a housing comprising a first surface exposed to the outside, open in the upward direction, and comprises a first sound insulating member comprising a sound insulating material in which a compressor is accommodated in an internal space thereof; and at least one first anti-vibration groove formed on the first surface of the first sound insulating member.

### CROSS-REFERENCE TO RELATED APPLICATIONS

This application is a continuation of International Application No. PCT/KR2022/019121 designating the United States, filed on Nov. 29, 2022, in the Korean Intellectual Property Receiving Office and claiming priority to Korean Patent Application No. 10-2022-0012826, filed on Jan. 28, 2022, in the Korean Intellectual Property Office, the disclosures of each of which are incorporated by reference herein in their entireties.

### BACKGROUND

### Field

The disclosure relates to an apparatus for reducing noise of a compressor provided in an outdoor unit that makes up an air conditioning device (e.g., an air conditioner).

### Description of Related Art

Apparatuses or devices used in an air conditioning facility may vary depending on its air conditioning scheme, and may be roughly categorized as an air conditioning device, a heat source device, a refrigerant carrier system or the like. In general, an air conditioning device such as e.g., an air conditioner may include a housing to house such an air conditioning unit therein. In order to reduce noise from a compressor, the housing may include materials with an overlapping structure of a sound-insulation member and a sound-absorption member.

The sound-insulation member of the housing may serve to block sound, and the sound-absorption member of the housing may serve to absorb sound. A combination of materials of the sound-absorption member and the sound-insulation member is referred to as a sound absorption/insulation member.

While the noise of 400 Hz or more generated from the compressor of the air conditioning device may be reduced with such a sound absorption/insulation member, the noise of 400 Hz or less may have a limited effect in reduction even using the sound absorption/insulation member, and low-frequency noise may be amplified due to vibrations of the sound-insulation member.

The thickness of the sound-insulation member applied to the compressor of the air conditioning device may have a uniform structure. In such a structure of sound-insulation member, vibrations may occur on its surface due to vibration or sound of the compressor, which is transmitted to the entire sound-insulation member to cause vibration like a plate, thereby amplifying low-frequency noise (especially in 400 Hz or less).

### SUMMARY

Embodiments of the disclosure may provide an air conditioning device provided with an anti-vibration groove on a surface of a sound-insulation member that shields noise generated by a compressor provided in an outdoor unit.

Embodiments of the disclosure provide a noise shielding device capable of improving a phenomenon of noise amplification, by forming at least one anti-vibration groove on the surface of the sound-insulation member for improving the phenomenon of the low-frequency noise of 400 Hz or less being amplified, and even if vibrations occur on the surface of the sound-insulation member, minimizing and/or reducing transmission of the vibrations throughout the sound-insulation member.

According to an example embodiment of the disclosure, an air conditioning device may comprise: one or more indoor units, an outdoor unit connected via piping to the one or more indoor units and including a compressor, and a housing configured to be opened upward and including a first sound-insulation member comprising a sound-insulating material accommodating the compressor in an inner space thereof, and wherein at least one first anti-vibration groove may be formed on a first surface exposed to an outside in the first sound-insulation member included in the housing.

According to an example embodiment of the disclosure, a housing configured to shield noise from a compressor provided in an outdoor unit of an air conditioning device may comprise: a sound-insulation member comprising a sound-insulating material having an inner space, opening upward, and including one surface exposed to an outside; and at least one anti-vibration groove formed on the one surface.

According to various example embodiments of the disclosure, it is possible to minimize and/or reduce the phenomenon of amplification of low frequency noise of 400 Hz or less, by forming at least one anti-vibration groove on the surface of the housing provided for shielding noise generated by an outdoor unit of an air conditioning device.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a perspective view illustrating a compressor and a housing before the compressor is accommodated in the housing, according to various embodiments;

FIGS. 2A and 2B are diagrams illustrating plan views of a sound-insulation member of FIG. 1 having an anti-vibration groove according to various embodiments;

FIG. 3 is a cross-sectional view taken along line A-A′ of FIG. 2A or 2B, according to various embodiments;

FIG. 4 is a diagram illustrating an example process of attenuation of vibrations generated in a sound-insulation member, according to various embodiments;

FIG. 5 is a graph illustrating an experimental result of alleviating noise due to a compressor in an air conditioning device, according to various embodiments;

FIG. 6 is a perspective view illustrating a compressor before the compressor is accommodated in a housing, and a housing to which a sound-insulation cover is coupled, according to various embodiments; and

FIGS. 7A and 7B are diagrams illustrating plan views of a sound-insulation member of claim 6 having an anti-vibration groove according to various embodiments.

In conjunction with the description of the drawings, the same or like reference numerals may be used to denote the same or like components.

### DETAILED DESCRIPTION

Hereinafter, various example embodiments of the disclosure will be described in greater detail with reference to the accompanying drawings. However, the disclosure may be implemented in various different forms and is not limited to the various example embodiments described herein. With regard to description of drawings, the same or like components may be indicated by the same or like reference numerals. Further, in the drawings and their related descriptions, well-known descriptions of functions and configurations may be omitted for clarity and brevity.

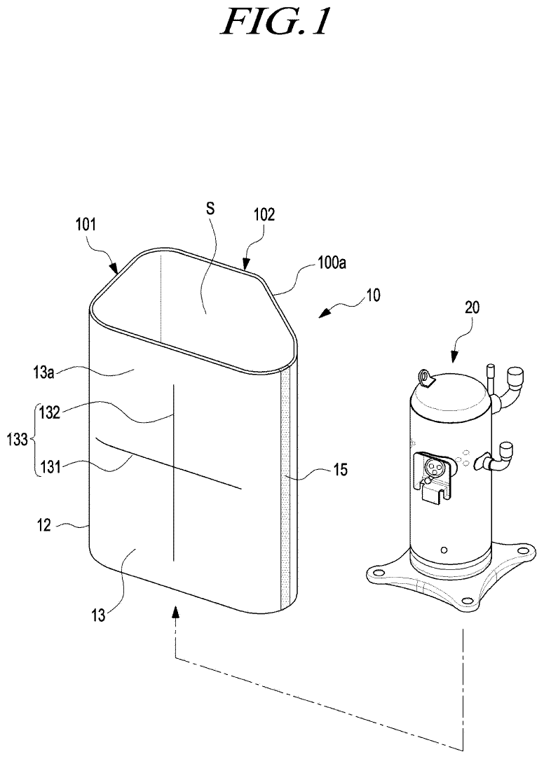

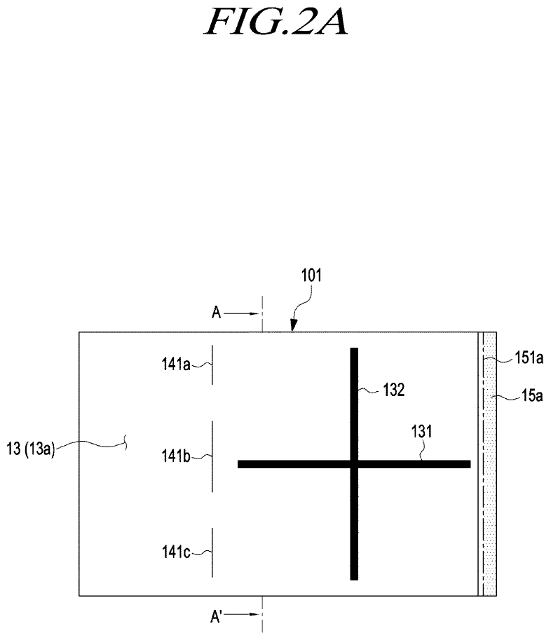

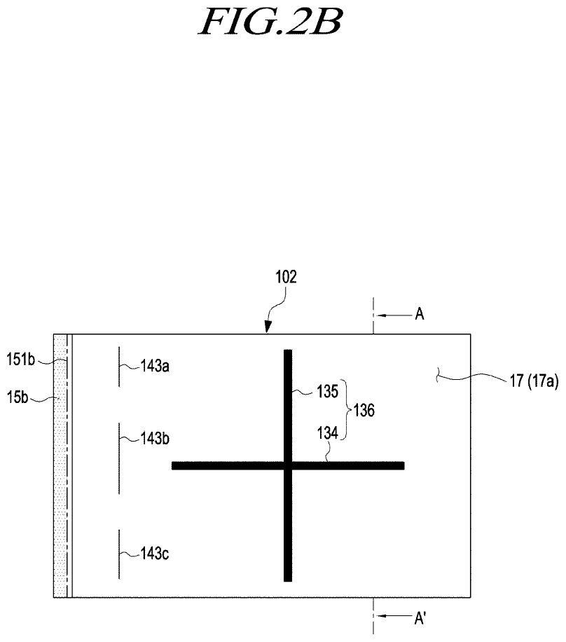

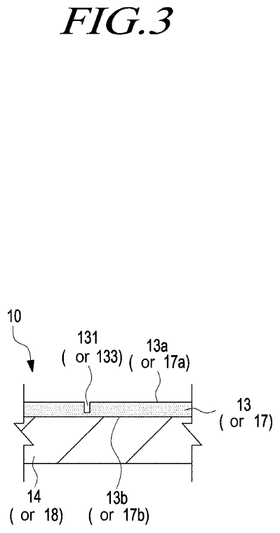

FIG. 1 is a perspective view illustrating a compressor and an example housing before the compressor is accommodated in the housing, according to various embodiments. FIGS. 2A and 2B are diagrams illustrating plan views of a sound-insulation member of FIG. 1 having an anti-vibration groove according to various embodiments. FIG. 3 is a cross-sectional view taken along line A-A′ of FIG. 2A or 2B according to various embodiments.

Referring to FIGS. 1, 2A, 2B and 3 (which may be referred to as FIGS. 1 to 3), an air conditioning device according to an embodiment may include one or more indoor units, an outdoor unit connected to the one or more indoor units via piping, and a housing 10. The outdoor unit may include a unit 20 (e.g., a compressor) disposed inside the housing 10 and generating noise. According to an embodiment, the unit 20 generating noise may be accommodated in an inner space (S) of the housing 10 in an upright state to be isolated from an outside. In this case, the noise generated in the unit 20 may be primarily reduced by the housing 10.

According to an embodiment, the housing 10 may include a first housing 101 and a second housing 102 that may be detachably coupled to the first housing 101. The second housing 102 may be coupled to or separated from the first housing 101 using an attachment device 15. The attachment device 15 may be implemented using, for example, a Velcro tape or a separate member such as a locking structure. The Velcro tape may have a structure in which a hook member is provided at one side and a locking-ring member is provided at the other side, so that the hook member and the locking-ring member are in contact with each other and fastened together. A first attachment device 15a may be provided with a first sewing line 151a for connection with a first sound-insulation member 13. The first sound-insulation member 13 may be comprises a sound-insulation material.

According to an embodiment, the housing 10 may be open upward. The first housing 101 included within the housing 10 may include the first sound-insulation member 13 having a first front surface 13a exposed to the outside. The second housing 102 included within the housing 10 may also include a second sound-insulation member 17 having a second front surface 17a exposed to the outside. The second sound-insulation member 17 may be comprises a sound-insulating material. Hereinafter, while the description will focus on the first housing 101, the structure provided on the surface of the first housing 101 may be the same as or similarly applied to the second housing 102. The first front surface 13a of the first sound-insulation member 13 or the second front surface 17a of the second sound-insulation member 17 may be, for example, an outer surface.

According to an embodiment, the first front surface 13a of the first sound-insulation member 13 may be any one of a flat surface, a curved surface, or a combination thereof. The second front surface 17a of the second sound-insulation member 17 may be any one of a flat surface, a curved surface, or a combination thereof.

According to an embodiment, the first sound-insulation member 13 may have at least one first anti-vibration groove 133 formed in the first front surface 13a. The first anti-vibration groove 133 may be formed, for example, in either a single groove or multiple grooves. The first anti-vibration groove 133 may be formed in a vertical direction and/or a horizontal direction, but the groove is not necessary to be limited to that vertical and/or horizontal direction. For example, the first anti-vibration groove 133 may be formed in a diagonal direction.

According to an embodiment, the at least one first anti-vibration groove 133 formed in the first front surface 13a of the first sound-insulation member 13 may be formed in a grid pattern, but it may be formed in other shapes such as e.g., a rhombus shape, without being limited to such a grid-like pattern.

According to an embodiment, a plurality of first anti-vibration grooves 133 may be formed at equal intervals on the first front surface 13a of the first sound-insulation member 13, but the disclosure is not necessarily limited to such an arrangement at equal intervals. For example, as the plurality of first anti-vibration grooves 133 get closer to the first attachment device 15a, a gap between the plurality of first anti-vibration grooves 133 may become either narrower or wider. The first attachment device 15a may be provided with a first sewing line 151a for connection with the first sound-insulation member 13.

According to an embodiment, while the at least one first anti-vibration groove 133 formed in the first front surface 13a of the first sound-insulation member 13 is formed in a straight line, the groove is not limited to such a straight line and may be formed in either an oblique line or a curved line.

According to an embodiment, a cross-section of the first anti-vibration groove 133 need not be limited to a rectangular shape, and it may be formed in any one of e.g., a square, a triangle, or a semicircular shape.

According to an embodiment, the first anti-vibration groove 133 may include at least one of at least one first anti-vibration horizontal groove 131 or at least one first anti-vibration vertical groove 132. The at least one first anti-vibration horizontal groove 131 and the at least one first anti-vibration vertical groove 132 may be formed to meet each other at one or more points. The at least one first anti-vibration horizontal groove 131 and the at least one first anti-vibration vertical groove 132 may be formed, for example, to vertically intersect each other, at one or more intersection points.

According to an embodiment, the thickness of the first anti-vibration horizontal groove 131 and/or the first anti-vibration vertical groove 132 may be formed to be substantially similar to one half of the thickness of the first sound-insulation member 13, or less than one half of the thickness of the first sound-insulation member 13, or greater than one half of the thickness of the first sound-insulation member 13. The thickness of the first anti-vibration horizontal groove 131 and/or the first anti-vibration vertical groove 132 may be defined, for example, to the extent that the shape of the housing 10 is not deformed.

According to an embodiment, when the unit 20 is accommodated in the housing 10, the first sound-insulation member 13 may be provided with one or more incisions (141a, 141b, 141c) in a vertical direction in vicinity of an edge 12 so as to facilitate formation of such a bent edge 12. The one or more incisions (141a, 141b, 141c) may be formed to penetrate the first housing 101 to reach the inner space(S) from the first front surface 13a of the first sound-insulation member 13. The lengths of the one or more incisions (141a, 141b, 141c) may be determined based on the number of incisions provided therein.

According to an embodiment, the second sound-insulation member 17 may have at least one second anti-vibration groove 136 formed in the second front surface 17a. The second anti-vibration groove 136 may be formed, for example, in either a single groove or a plurality of grooves. The second anti-vibration groove 136 may be formed in either a vertical direction and/or a horizontal direction, but it is not limited to such a vertical and/or horizontal direction. For example, the second anti-vibration groove 136 may be formed in a diagonal direction.

According to an embodiment, the at least one second anti-vibration groove 136 formed in the second front surface 17a of the second sound-insulation member 17 may be formed in a grid-like pattern, but may be formed in another shape such as e.g., a rhombus shape, without being limited to such a grid-like pattern.

According to an embodiment, a plurality of second anti-vibration grooves 136 may be formed at equal intervals on the second front surface 17a of the second sound-insulation member 17, but the disclosure is not limited to such an arrangement at equal intervals. For example, as the plurality of second anti-vibration grooves 136 get closer to the second attachment device 15b, the gap between the plurality of second anti-vibration grooves 136 may become narrower or wider. The second attachment device 15b may be provided with a second sewing line 151b for connection with the second sound-insulation member 17.

According to an embodiment, the at least one second anti-vibration groove 136 formed in the second front surface 17a of the second sound-insulation member 17 is formed in a straight line, but it is not limited to such a straight line and may be formed in either an oblique line or a curved line.

According to an embodiment, the cross-section of the second anti-vibration groove 136 need not be limited to a rectangle, and it may be formed in any one of a square, a triangle, or a semicircular shape.

According to an embodiment, the second anti-vibration groove 136 may include at least one of at least one second anti-vibration horizontal groove 134 or at least one second anti-vibration vertical groove 135. The at least one second anti-vibration horizontal groove 134 and the at least one second anti-vibration vertical groove 135 may be formed to meet each other at one or more points. The at least one second anti-vibration horizontal groove 134 and the at least one second anti-vibration vertical groove 135 may be formed to vertically intersect, for example, at one or more intersection points.

According to an embodiment, the thickness of the second anti-vibration horizontal groove 134 and/or the second anti-vibration vertical groove 135 may be formed to be substantially similar to one half of the thickness of the second sound-insulation member 17, or less than one half of the thickness of the second sound-insulation member 17, or greater than one half of the thickness of the second sound-insulation member 17. The thickness of the second anti-vibration horizontal groove 134 and/or the second anti-vibration vertical groove 135 may be defined, for example, to the extent that the shape of the housing 10 is not deformed.

According to an embodiment, when the unit 20 is accommodated in the housing 10, the second sound-insulation member 17 may be provided with one or more incisions (143a, 143b, 143c) in the vertical direction in vicinity of the edge so as to facilitate formation of the bent edge. The one or more incisions (143a, 143b, 143c) may be formed to penetrate the second housing 102 to reach the inner space (S) from the second front surface 17a of the second sound-insulation member 17. The lengths of the one or more incisions (143a, 143b, 143c) may be determined based on the number of incisions provided therein.

Referring to FIG. 3, the thickness (or depth) of the first anti-vibration horizontal groove 131 (or the second anti-vibration horizontal groove 134) included in the first anti-vibration groove 133 (or the second anti-vibration groove 136) according to an embodiment may be formed to be substantially similar to one half of the thickness of the first sound-insulation member 13 (or the second sound-insulation member 17), or less than or larger than one half of the thickness of the first sound-insulation member 13 (or the second sound-insulation member 17). The thickness of the first anti-vibration groove 133 (or the second anti-vibration groove 136) may be defined, for example, such that the shape of the housing 10 (in a state of the first housing 101 and the second housing 102 being coupled) is not deformed.

According to an embodiment, a material of the first housing 101 may have a structure in which the first sound-insulation member 13 and a first sound-absorption member 14 overlap each other. The first sound-absorption member 14 may be comprises a sound absorbing material. According to an embodiment, the first sound-absorption member 14 may be made of a porous material, for example, a material such as felt.

According to an embodiment, the first sound-insulation member 13 may include a first rear surface 13b (an inner surface) facing the inner space (S) of the first housing 101 and a first front surface 13a (an outer surface) facing the outside of the first housing 101. According to an embodiment, the first sound-absorption member 14 may be attached to the inner surface 13b of the first sound-insulation member 13.

According to an embodiment, a material of the second housing 102 may have a structure in which the second sound-insulation member 17 and a second sound-absorption member 18 overlap each other. The second sound-absorption member 18 may be comprises a sound absorbing material. According to an embodiment, the second sound-absorption member 18 may be made of a porous material, for example, a material such as felt.

According to an embodiment, the second sound-insulation member 17 may include a second rear surface 17b (an inner surface) facing the inner space (S) of the second housing 102 and a second front surface 17a (an outer surface) facing the outside of the second housing 102. According to an embodiment, the second sound-absorption member 18 may be attached to the inner surface 17b of the second sound-insulation member 17.

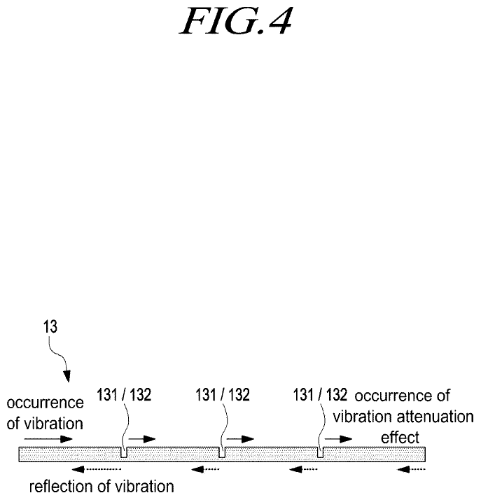

FIG. 4 is a diagram illustrating an example process of attenuation of vibrations generated in the sound-insulation member, according to various embodiments.

Referring to FIG. 4, according to an embodiment, when a difference in the material or surface cross-sectional area of the housing 10 occurs in a transmission path of noise/vibrations generated in the surface of the housing 10 (e.g., the first housing 101 of FIG. 2A or the second housing 102 of FIG. 2B), a noise or vibration reflection may be generated at the corresponding portion (e.g., due to impedance mismatching), and a vibration reflection may be generated using the difference in the cross-sectional area of the noise or vibration transmission path.

According to an embodiment, vibrations are generated in a certain portion of the first sound-insulation member 13 or the second sound-insulation member 17, which vibrations are transmitted through one surface of the first sound-insulation member 13 or the second sound-insulation member 17, and some vibrations are then reflected at a portion where the cross-sectional area rapidly changes in the sound transmission path (e.g., a portion where the first anti-vibration groove 133 is formed or another portion where the second anti-vibration groove 136 is formed), consequently resulting in an overall vibration attenuation effect in the course of propagating the vibration throughout the first sound-insulation member 13 or the second sound-insulation member 17.

Assuming that the first sound-insulation member 13 or the second sound-insulation member 17 according to an embodiment is an infinite plate, as the vibration (vibration speed v) of the first sound-insulation member 13 or the second sound-insulation member 17 is reduced, the acoustic power generated by the plate vibration may decrease in proportion to the square of the vibration speed, as defined by Equation 1 below,

[Equation 1]

W=ρcsυ²
wherein W is an acoustic power (Watt),
ρ is a density of air (kg/m²),
c is an air speed (m/s),
s is an area of sound-insulation material (m²), and
v is a vibration speed of sound-insulation material (m/s²)

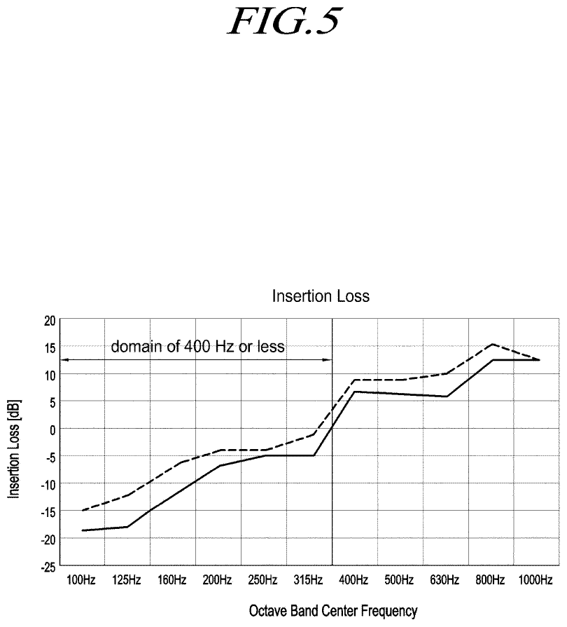

FIG. 5 is a graph illustrating an experimental result indicative of alleviating noise due to a compressor in an air conditioning device, according to various embodiments.

Referring to FIG. 5, the insertion loss may refer to a difference between the noise from a sound source (e.g., compressor 20) and the noise when the sound source is sealed with the sound-absorption member (e.g., the first sound-absorption member 14 of FIG. 3 or the second sound-absorption member 18 of FIG. 3) and/or the sound-insulation member (e.g., the first sound-insulation member 13 of FIG. 3 or the second sound-insulation member 17 of FIG. 3). The solid line graph represents the noise caused by the sound source when the source is not sealed by the sound-absorption member and/or the sound-insulation member. The dashed line graph represents the noise caused by the sound source when the source is sealed by the sound-absorption member and/or the sound-insulation member.

According to an embodiment, the insertion loss greater than zero may refer, for example, to the noise being reduced after applying the first sound-absorption member/the first sound-insulation member compared to before applying the first sound-absorption member/the first sound-insulation member, and conversely, the insertion loss less than zero may refer, for example to the noise being amplified.

According to an embodiment, in the case of the sound-absorption member/sound-insulation member to be provided in the compressor 20 of the air conditioning device, the noise is inversely amplified due to the vibration of the sound-insulation member in a region of 400 Hz or less, and thus the insertion loss value may usually have a value of zero or less.

In conclusion, according to an embodiment, the insertion loss in the region (e.g., 400 Hz or less) where the insertion loss becomes zero or less shows an effect that the octave band average is improved by 3.7 dB.

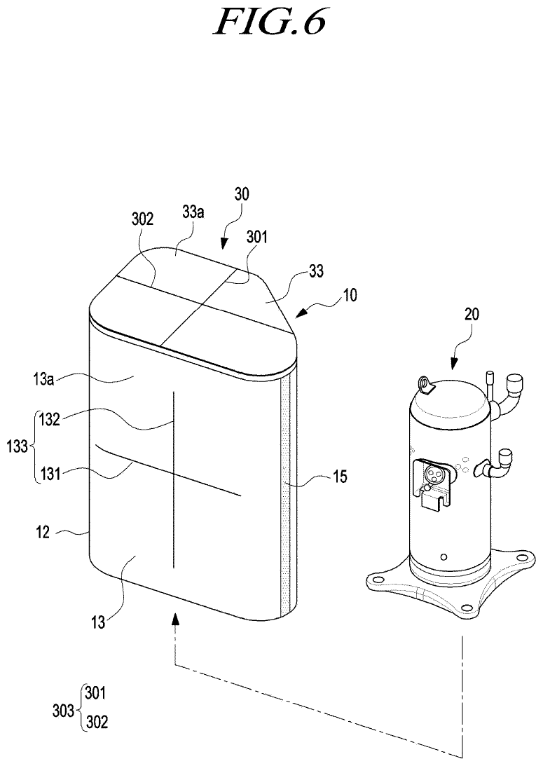

FIG. 6 a perspective view illustrating a compressor before being accommodated in a housing, and the housing to which the sound-insulation cover is coupled, according to various embodiments.

Referring to FIG. 6, a sound-insulation cover 30 may be coupled to a upper end of the housing 10. According to an embodiment, the sound-insulation cover 30 may open and close a top end 100a (e.g., the upper end 100a illustrated in FIG. 1) of the housing 10 and may cause the compressor 20 accommodated therein to be spatially closed from the outside.

According to an embodiment, the sound-insulation cover 30 may be configured substantially the same as or at least partially the same as the structure of the first sound-insulation member 13 and the first sound-absorption member 14 illustrated in FIGS. 2A and/or 3.

According to an embodiment, the sound-insulation cover 30 may include a third sound-insulation member (e.g., the first sound-insulation member 13 or the second sound-insulation member 17 of FIG. 3) and a third sound-absorption member (e.g., the first sound-absorption 14 or the second sound-absorption member 18 of FIG. 3) attached to one surface of the third sound-insulation member. According to an embodiment, the third sound-insulation member may include a third front surface 33 exposed to the outside. According to an embodiment, the third front surface 33 of the sound-insulation cover 30 may include at least one third anti-vibration groove 303. According to an embodiment, the number of the third anti-vibration grooves 303 may be singular or plural to form a grid-like pattern. According to an embodiment, the third front surface 33 of the sound-insulation cover 30 may be divided into several sections by a plurality of third anti-vibration grooves 303.

According to an embodiment, in case where a plurality of third anti-vibration grooves 303 are formed, the third anti-vibration grooves 303 may be formed at equal intervals, but the disclosure is not limited to such an equal interval of arrangement.

According to an embodiment, the third anti-vibration groove 303 is formed in a linear shape, but it does not need to be limited to such a linear shape, and may be formed in a diagonal shape or a curved shape.

According to an embodiment, the third anti-vibration groove 303 may include at least one (3-1)th anti-vibration groove 301 and at least one (3-2)th anti-vibration groove 302. According to an embodiment, the (3-1)th anti-vibration groove 301 and the (3-2)th anti-vibration groove 302 may be formed to meet each other at one or more points. According to an embodiment, the (3-1)th anti-vibration groove 301 and the (3-2)th anti-vibration groove 302 may be formed to intersect at one or more intersection points.

The thickness of the third anti-vibration groove 303 according to an embodiment may be substantially similar to one half of the thickness of the third sound-insulation member, or may be less than or larger than one half of the thickness of the third sound-insulation member.

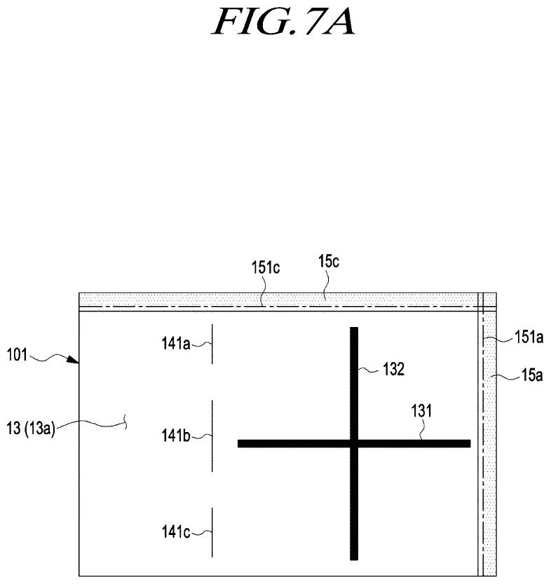

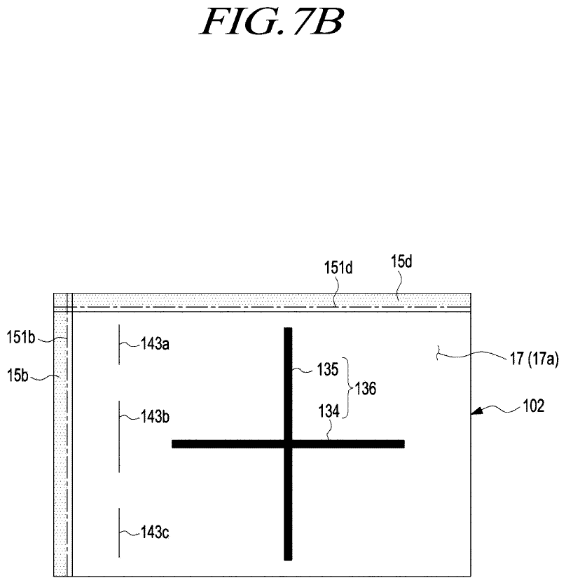

FIGS. 7A and 7B are diagrams illustrating plan views of a sound-insulation member of FIG. 6 having an anti-vibration groove according to various embodiments.

The planar structure of the first sound-insulation member 13 illustrated in FIG. 7A may be substantially almost the same as the structure of the first sound-insulation member 13 described with reference to FIG. 2A, but an attachment device 15c may be further provided to be coupled to or separated from the sound-insulation cover 30 at the upper end of the first sound-insulation member 13. The attachment device 15c may be implemented using, for example, a Velcro tape or a separate member such as a locking structure. The Velcro tape may have, for example, a structure in which a hook member is provided at one side and a locking-ring member is provided at the other side, so that the hook member and the locking-ring member come into contact with each other to be fastened together. The attachment device 15c may be provided with a sewing line 151c for connection with the first sound-insulation member 13.

The planar structure of the second sound-insulation member 13 illustrated in FIG. 7B may be substantially almost the same as the structure of the second sound-insulation member 17 described with reference to FIG. 2B, but another attachment device 15d may be further provided to be coupled to or separated from the sound-insulation cover 30 at the upper end of the second sound-insulation member 17. The attachment device 15d may be implemented using, for example, a Velcro tape or a separate member such as a locking structure. The Velcro tape may have, for example, a structure in which a hook member is provided at one side and a locking-ring member is provided at the other side, so that the hook member and the locking-ring member come into contact with each other to be fastened together. The attachment device 15d may be provided with a sewing line 151d for connection with the second sound-insulation member 17.

The terms used in the disclosure are used simply to describe certain embodiments and are not intended to limit the disclosure. For example, an element expressed in a singular should be understood as a concept including a plurality of elements unless the context clearly refers to only the singular. As used in the disclosure, each of the phrases such as “A or B”, “at least one of A and B”, “at least one of A or B”, “A, B or C”, “at least one of A, B and C”, and “at least one of A, B, or C” may include any one of the items enumerated together in a corresponding one of the phrases, or all possible combinations thereof. Further, it should be understood that the term ‘and/or’ as used herein is intended to encompass any and all possible combinations of one or more of the enumerated items. As used in the disclosure, the terms such as ‘comprise(s)’, ‘include(s)’ ‘have/has’, ‘configured of’, etc. are only intended to designate that the features, components, parts, or combinations thereof described in the disclosure exist, and the use of these terms is not intended to exclude the possibility of the presence or addition of one or more other features, components, parts, or combinations thereof. As used herein, the expressions such as ‘first’, ‘second’, etc. may refer to various components in any order and/or importance, and are only used to distinguish one component from another component and are not intended to limit the corresponding components thereto.

As used in the disclosure, the expression ‘configured to˜’ may be used interchangeably with, depending on the context, for example, ‘suitable for˜’, ‘having the ability to˜’, ‘designed to˜’, ‘modified to˜’, ‘made to˜’, ‘capable of˜’ or the like. The term ‘configured to˜’ may not necessarily refer to only ‘specially designed to˜’ in hardware. Instead, in some circumstances, the expression ‘a device configured to˜’ may refer, for example, to the device being ‘capable of˜’ together with another device or component. For example, a phrase ‘a device configured (adapted) to perform A, B, and C’ may imply a dedicated device for performing a corresponding operation or imply a general-purpose device capable of performing various operations including the corresponding operation.

Meanwhile, the terms ‘upper’, ‘lower’, and ‘forward/backward direction’ used in the disclosure are defined on the basis of the drawings, and the shape and position of each component are not limited by those terms.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An air conditioning device, comprising:
one or more indoor units;
an outdoor unit connected via piping to the one or more indoor units and including a compressor; and
a housing opening upward and including a first sound-insulation member comprising a sound-insulation material accommodating the compressor in an inner space thereof, and
wherein a first anti-vibration groove is formed in a first surface of the first sound-insulation member of the housing exposed to an outside.

2. The air conditioning device of claim 1, wherein a plurality of first anti-vibration grooves are formed at equal intervals from each other in the first sound-insulation member.

3. The air conditioning device of claim 2, wherein the first anti-vibration grooves are formed in a straight line.

4. The air conditioning device of claim 1, wherein the first anti-vibration groove comprises:
at least one first anti-vibration horizontal groove; and
at least one first anti-vibration vertical groove meeting the at least one first anti-vibration horizontal groove.

5. The air conditioning device of claim 1, wherein the at least one first anti-vibration horizontal groove and the at least one first anti-vibration vertical groove intersect with each other, and at least one intersection point is formed.

6. The air conditioning device of claim 1, wherein a depth of the first anti-vibration groove is approximately one half of a thickness of the first sound-insulation member.

7. The air conditioning device of claim 1, wherein a first sound-absorption member comprising a sound absorbing material is attached to a second surface of the first sound-insulation member facing the inner space of the housing.

8. The air conditioning device of claim 1, wherein a plurality of incisions are provided in the first sound-insulation member to reach the inner space from the first surface in a specified vicinity of a vertical edge bent to accommodate the compressor in the housing.

9. The air conditioning device of claim 1,
wherein based on a sound-insulation cover being coupled to an upper end of the housing, the inner space is closed;
wherein the sound-insulation cover comprises:
a second sound-insulation member comprising a sound-insulating material, and
a second sound-absorption member comprising a sound-absorbing material attached to one surface of the second sound-insulation member.

10. The air conditioning device of claim 9, wherein at least one second anti-vibration groove is formed on one surface of the second sound-insulation member exposed to an outside.

11. The air conditioning device of claim 10, wherein the at least one second anti-vibration groove extends in a straight line.

12. The air conditioning device of claim 10, wherein the at least one second anti-vibration groove comprises:
at least one second anti-vibration horizontal groove; and
at least one second anti-vibration vertical groove meeting the at least one second anti-vibration horizontal groove.

13. The air conditioning device of claim 12, wherein the at least one second anti-vibration horizontal groove and the at least one second anti-vibration vertical groove intersect with each other and at least one intersection point is formed.

14. The air conditioning device of claim 10, wherein a depth of the at least one second anti-vibration groove is approximately one half of a thickness of the second sound-insulation member.

15. The air conditioning device of claim 1, wherein the housing comprises:
a first housing, and
a second housing coupled to the first housing,
wherein the first housing and the second housing are attachable to and detachable from each other by Velcro.

16. A housing for shielding noise from a compressor provided in an outdoor unit of an air conditioning device, comprising:
a sound-insulation member comprising a sound-insulating material having an inner space, opening upward, and including one surface exposed to an outside; and
at least one anti-vibration groove formed on the one surface of the sound-insulation member.

17. The housing of claim 16, wherein the anti-vibration groove comprises:
at least one first anti-vibration groove; and
at least one second anti-vibration groove meeting the at least one first anti-vibration groove.

18. The housing of claim 16, wherein each of the anti-vibration grooves extends in a straight line.

19. The housing of claim 16, wherein a depth of the anti-vibration groove is approximately one half of a thickness of the sound-insulation member.

20. The housing of claim 16, wherein a plurality of incisions having a specified length are formed along an edge bent in the housing.
